(19) United States
(12) Patent Application Publication
(10) Pub. No.: US 2026/0270178 A1
(43) Pub. Date: Sep. 10, 2026

(54) ANALYZING AND MODELING THE JITTER AND DELAY BEHAVIOR OF, IN PARTICULAR, MIXED INDUSTRIAL TIME-SENSITIVE NETWORKS

(71) Applicant: HIRSCHMANN AUTOMATION AND CONTROL GMBH, Neckartenzlingen (DE)

(72) Inventors: Lukas BECHTEL, Stuttgart (DE); David HELLMANNS, Schrondorf (DE)

(73) Assignee: HIRSCHMANN AUTOMATION AND CONTROL GMBH, Neckartenzlingen (DE)

(21) Appl. No.: 18/880,182

(22) PCT Filed: Jun. 30, 2022
(86) PCT No.: PCT/EP2023/067493

§ 371 Date: Dec. 30, 2024

(30) Foreign Application Priority Data
Jun. 30, 2022 (DE) 10 2022 116 325.3

(51) Int. Cl. H04L 43/087; H04L 43/106

(52) U.S. Cl. CPC H04L 43/087; H04L 43/106

(57) ABSTRACT

The invention relates to a method for operating a network, wherein multiple network devices, each having their own configuration, are connected to one another for data exchange and exchange data via these connections, wherein dynamic delays (jitters) are taken into account in the determining of the time for the transmission of the data, wherein the network is a time-sensitive network and an actual time for the transmission of the data over network devices from a starting network device to a target network device is determined while taking the dynamic delays into account, wherein time synchronisation jitters and forwarding jitters are taken into account in the dynamic delays.

The invention relates to a method for operating a network, wherein multiple network devices, each having their own configuration, are connected to one another for data exchange and exchange data via these connections, wherein dynamic delays (jitter) are taken into account when determining the time for the transmission of the data, in accordance with the features of the preamble of claim 1.

Such methods are already known. This will be discussed in detail below in the description (in particular in Section 1). The determination of the time for the transmission of data, in which dynamic delays (jitter) are taken into account, has already brought improvements in the performance of network operation in the state of the art. However, these methods cannot be applied to all, in particular not to all mixed industrial networks, as not all components of the network, in particular their network devices such as switches, hubs or the like, are designed and suitable for this purpose. This is also discussed with regard to the resulting disadvantages in the description below (in particular in Section 2).

The invention is therefore based on the object of improving such a known method with regard to its performance, in particular with regard to the speed of the transmission time, and also to achieve a more general applicability.

This object is achieved by the features of claim 1.

According to the invention, it is provided that the network is a time-sensitive network and that an actual time for the transmission of the data over the network devices from a starting network device to a target network device is determined while taking the dynamic delays into account, wherein time synchronization jitters and forwarding jitter are taken into account in the dynamic delays. As a result, the transmission behavior of a network, in particular the time for data transmission, can be analyzed theoretically after modeling the network behavior and/or after measuring the network behavior of a network in practice and, based on this, can be determined much more precisely than was possible in the prior art. In this regard, reference is made in particular to Section 4.3 (1st paragraph) in conjunction with Section 7.3.1 (2nd paragraph) of the description below for additional and more precise information.

In a specific further development of the invention, it is provided that each network device inserts a time stamp into a data frame on its ingress port and on its egress port. In this regard, reference is made in particular to Section 6.1, 1st paragraph, of the description below for additional and more precise information.

In the further development of the invention, it is provided that a theoretical time for the transmission of the data over the network devices from the starting network device to the target network device is determined. The theoretical time for data transmission can be determined mathematically if a network is planned without it first being set up in practice using hardware components.

The configuration of the entire network, parts of the network and/or its individual components (in particular its network devices) can be changed (modeled) and the resulting times, i.e. their change, can be determined for the data transmission. Conclusions can be drawn from the changes identified and measures derived as to how the overall configuration or individual configurations need to be changed in order to improve (in particular speed up) data transmission within the network. In this regard, reference is made in particular to Section 7.3.1 (2nd paragraph) of the description below for additional and more precise information.

In the further development of the invention, it is planned that the actual time determined is compared with the theoretically determined time. The comparison can be used to determine whether a change made to the set configuration has led to an improvement (or possibly a deterioration) in the data transmission time. Accordingly, the configuration can be changed again and a further determination of the time can be made. This can be done until a time has been determined that is sufficient or satisfactory for data transmission. The theoretical planning of the network is then completed and the components of the network are configured accordingly and the network is set up in practice with these configured components.

In this regard, in a further development of the invention, it is provided that if the comparison exceeds a predeterminable threshold value, the configuration of at least one network device is changed for debugging purposes between the starting network device and the target network device. Thus, changing the respective configuration can influence network behavior to improve (in the sense of shorten) the time for data transmission. This is possible both when planning a network that does not yet exist in reality and for realized networks, i.e. networks that have already been set up.

According to the invention, it is conceivable that the method according to the invention is only carried out between two network devices which are connected to one another and exchange data via this connection. It is also conceivable that the method according to the invention is carried out across more than two network devices present in the topology of the network device. Thus, any parts of the network or of a neighboring or subordinate network can be selected, the time for data transmission of which is determined in theory and improved after modeling their configuration. The same applies to parts of a network that has already been set up and exists in reality.

In a further development of the invention, it is provided that the configuration of the starting network device and/or the target network device is also changed. In this case, the behavior of an entire network is considered and its time behavior is improved.

Finally, in a further development of the invention, it is provided that the configuration of the at least one network device is changed until the comparison no longer exceeds the predeterminable threshold value. After changing the configuration (debugging) of a single network device, a group of network devices or all network devices of the network under consideration, the time response of this network is optimized.

The method according to the invention thus has the substantially advantage that the time behavior of the network can be analyzed theoretically before its setup, but additionally or alternatively also after its setup in reality and its commissioning, and can be optimized by changing configurations (modeling). This is a significant advantage, especially for mixed industrial time-sensitive networks, such as TSN networks.

With regard to further specific steps of the method according to the invention, their implementation and the underlying technical approach (see in particular Section 3), reference is made to the following description.

### SUMMARY

New industrial technologies such as edge computing and control from the cloud are transforming factory automation networks from isolated purpose-built real-time networks to large, highly connected multi-purpose networks. At the heart of this development are real-time-capable factory backbone networks that connect various production lines and machines. IEEE time-sensitive networking (TSN) and IETF deterministic networking (DetNet) offer a range of new mechanisms for networks to realize both the factory backbone and the edge. These technologies promise to create ubiquitous deterministic communication across an entire industrial plant.

In practice, however, different parts of the factory network are deployed with different TSN mechanisms to achieve their specific quality and service requirements (QoS). This creates different TSN domains, based on different approaches to achieving real-time traffic forwarding. Since each domain can provide a different level of real-time QoS, guarantees do not apply to data traffic traversing a domain beyond its boundary. Therefore, it is difficult to predict delays and jitter for TSN when routing traffic between domains. It is therefore not easy to make reliable statements about the achievable QoS in larger plant networks.

In this article, we first define a model for time-critical communication across multiple TSN domains. With this model, we are able to evaluate the QoS requirements of industrial applications that require deterministic communication across multiple TSN domains. Our assessments with real measurements of industrial-grade TSN hardware demonstrate the feasibility and applicability of our model to predict the actual best case and worst case of delays in such a mixed TSN network. This makes it possible to guarantee a plant-wide QoS and helps to identify dangerous bottlenecks within these guarantees.

### 1. INTRODUCTION

Terms such as Industry 4.0, smart manufacturing, edge computing and big data require highly networked, ubiquitous determinism of communication networks. Today, however, factory networks often consist of isolated sub-networks that are more incompatible due to mutual manufacturer-specific communication technologies that require information exchange between gateways in these sub-networks. In addition, these plant sub-networks are installed and statically configured just once and are not designed for dynamic reconfiguration. An important driver for this manufacturer-specific and static network architecture is to fulfill the real-time requirements of industry. Machine suppliers are liable for the continuous and safe operation of their machine after it has passed extensive certification. Therefore, the transformation leads to greater inner connectivity. The factory network requires a time-deterministic network that enables reliable and protected communication for time-critical and non-critical communication without reconfiguration. Finally, the industry is moving towards a uniform communication standard with IEEE time-sensitive networking (TSN), which can be expanded to include IEEE Ethernet for real-time capabilities. For networks that span multiple Layer 2 networks, the IETF is working on the “Deterministic Networking” (DetNet) specification via the TSN specification to enable the routing of TSN traffic. Provider-specific communication technologies are mutually incompatible due to specific and proprietary improvements. Therefore, TSN must replace manufacturer-specific communication technologies within machine networks with a standard that enables seamless communication between all components.

IEEE TSN is a family of standards developed by the IEEE 802.1 group and extends IEEE Ethernet with additional scheduling algorithms to enable hard real-time guarantees. Two of these schedulers fundamentally change how frames are selected by switches for transmission: First, the time-aware shaper (TAS) implements class-based time-division multiple access (TDMA), which is not labor-saving due to blocking the transmission of low-priority traffic within certain reserved time slots. With sufficient time synchronization in the network, the TAS even switches on a TDMA scheme at frame or stream level. Secondly, frame preemption, also known as FP mechanism, allows frames with high priority to be prioritized over frames with low priority during transmission. The low-priority transmission is continued when the transmission of the high-priority frames has been completed.

Various approaches for calculating schedules for TDMA mechanisms, such as TAS, have been proposed in the literature, e.g. [13, 18, 20, 21, 31]. However, all of these approaches assume that a standardized network requires three elements:
(1) common time synchronization across all forwarding nodes,
(2) using the same set of TSN mechanisms on legacy switches, and
(3) consistent configuration of the TSN mechanisms, e.g. same schedule on all switches

However, typical industrial networks are not uniform because they are different. Providers supply parts of the network. For example, a factory comprises machines from different manufacturers. Since machine vendors sell their machines in many different factories, but the machine network itself is self-contained and uniform, uniformity across an entire factory is very unusual. In addition, the providers optimize the components within the machine for efficient operation. Therefore, supporting maximum configurations in each machine to ensure uniformity in the factory is uneconomical. As a consequence, a large number of machines using TAS with high-precision time synchronization on FP without synchronization can have a wide range of heterogeneous network configurations. However, not all machines are completely independent. For example, robots in a production line may require joint time synchronization to enable collaborative work on a product.

To summarize: Factory networks are usually very heterogeneous environments and do not fulfill the assumptions of homogeneity. As a result, the above-mentioned approaches can be used within a single machine or groups of synchronized machines, but not across the entire network due to non-deterministic transitions between heterogeneous sub-networks.

To enable real-time guarantees of a network in a heterogeneous factory, we provide a model that formalizes the transition between different sub-networks. This paper describes the influence of various TSN mechanisms and the lack of time synchronization by developing a model for worst-case guarantees. Therefore, Section 3 introduces the prerequisites for our work and gives a brief overview of TSN mechanisms. Our contribution is threefold. First, we will analyze the influence of the various TSN mechanisms, heterogeneous TSN configuration (e.g. network cycle times) and varying connection speeds in Section 4. Second, in Section 5, we define a best-case and worst-case model covering TSN and DetNet streams of multiple independent TSN network segments, in addition to computing worst-case guarantees and end-to-end latency.

Our model enables the following use cases:
1) identifying costly configurations within the network,
2) validating applications with communication across different TSN domains, and
3) network debugging and error detection.

We open the code of our models to derive guarantees for arbitrary network configurations. We evaluate the model with measurements on commercially available industrial machines with TSN hardware in Section 6. The assessment of a TSN worst-case model on commercially available hardware is novel. Our results show feasibility and applicability. Finally, Section 2 discusses related work and Section 8 concludes our work.

Solutions for time-critical traffic are available in the Industry 4.0 and smart manufacturing scenarios. However, our gap analysis shows that technology alone is not enough, as it is limited to a single machine. Every industrial scenario requires a solution to enable these market trends. In fact, industrial scenarios include networks with 100 to 1,000 switches and routers. Therefore, the problem we are tackling is complex enough to require a tool-based analysis.

### 2. RELATED WORK

In this section, we present related research and discuss how our approach extends the state of the art. There are various areas of research in the context of real-time networking: Firstly, the research community is very active in calculating TAS or TDMA schedules for networks in general. We can further differentiate between approaches in pure schedule calculation and combined calculation of scheduling and routing. However, we consider these topics as orthogonal because we focus our research on the transition between multiple heterogeneous networks that are already predefined. Therefore, schedule calculation is not the subject of this paper and for further details we refer the reader to [11, 13, 14, 18-22, 29-31]. Secondly, we discuss various approaches to verify whether a network configuration, e.g. a calculated schedule, fulfills the promised real-time guarantees. We discuss these approaches in detail because they are highly important and they relate to our approach and show how we complement existing ones. Thirdly, we consider network calculus (NC) to be a complementary category, as it can be used for configuration verification and schedule design. We only focus on the use of NC in the context of TSR, as they form the basis for our approach. NC is a mathematical framework based on the minus-plus algebra for proving and we optimize it by delays for scenarios with a single TSN mechanism or multiple TSN mechanisms in combination.

### 2.1 Configuration Check

Checking schedules and more generally—is a complex task and therefore mostly included in scenarios with strict certification requirements such as in the aviation industry. There are many approaches and optimizations for aviation full-duplex (AFDX) in Ethernet networks and their configurations. Compared to our work, AFDX networks are comparable to individual TSN machine networks, as they are self-contained and uniform. Therefore, modeling approaches for AFDX networks assume a uniform configuration and time synchronization [8-10]. The components of an aircraft are usually specifically built or customized to be used in a certain combination and configuration. However, these networks are therefore uniform compared to factory networks, which consist of many components of different types and providers including standard products, so that we cannot assume uniformity. Therefore, a configuration check for TSN networks is not yet widely used. Gou et al [17], Lv et al [25] and Frimpong et al [16] each present independent approaches for TSN configuration check. However, all these approaches require a common time synchronization across all nodes in the network, which is not necessarily the case in plant networks.

### 2.2 Network Calculus (NC)

Network calculus is a mathematical framework for calculating with upper delay and buffer limits for a given network. With minus-plus algebra, NC models can provide tight delay limits. However, this precision comes at the expense of complexity. In contrast, our model uses a less sophisticated approach and we prioritize complexity reduction over reduction. Our assessments (see Section 6) show a small discrepancy between the calculated worst-case delay and the actual measurements. We therefore assume that this reduction is acceptable in these scenarios.

In addition to the complexity, another disadvantage of NC is that the models only work under the specific conditions for which they are designed. Examples of such models can be found in [12, 27, 33, 34]. As a concrete example, Zhao et al [35], provides an NC model to be computed for end-to-end delays for nodes that use exclusive TAS gates for the highest priority and the credit-based shaper (as specified in IEEE 802.1Qav [1]) for other time-critical traffic. If the prioritization were changed, the model would lose its applicability. This limitation of flexibility when combining TSN mechanisms and the limitation of NC is well known, as described by Maile et al. address in [26]. Since plant networks are very heterogeneous environments, the NC approach is inappropriate. In terms of our approach, we exchange the flexibility to be applicable in different scenarios, as opposed to the narrow confines of NC.

### 3 BACKGROUND

The need for time-deterministic communication is constantly growing in many sectors and industries. However, in order to reduce complexity, we will limit the scope of the presentation to industrial networks. Together with our industry partner, we are able to validate the scenarios and assumptions presented. This section introduces the prerequisites for discussing industrial control systems (ICS) based on next-generation ISN networks. After introducing an example architecture of an ICS network, we continue this section by presenting TSN and DetNet. Finally, we specify the traffic types that we use and cover in this whitepaper in Section 3.2.

### 3.1 Exemplary ICS Network Architecture

FIG. 1 presents an exemplary network architecture for ICS networks based on for the next generation. Industrial networks have a hierarchical structure for two reasons:
A) each network segment performs a dedicated task, and the above layers aggregate all networks with similar and related tasks,
B) for hierarchical security.

The structure introduces obvious interfaces to apply the concept of zones and lines [23]. Machine networks with controllers and all sensors and actuators are located at the lowest level. Each machine has a dedicated functionality and is designed and configured for the application. There are several aggregation levels above this level. FIG. 1 shows this from the production line and production backbone. Depending on the size of the deployment, the network comprises additional layers such as a mobile network.

Typically, the provider of a network segment has full knowledge of all functions in this network segment, but knows little about all external traffic. Due to dynamic manufacturing and changes in the production process, this lack of knowledge will increase in the future. Today, machine networks are isolated to compensate for this lack of knowledge and unwanted influences from critical applications. In future, the networks will be open to external data traffic in order to enable scenarios introduced by Industry 4.0 (e.g. virtual industrial controls). Therefore, time-critical traffic within the machine and time-critical traffic exiting and entering the machine requires QoS protection. The industrial market is focusing on TSN technology to achieve guaranteed QoS. We discuss the details of this technology in Section 3.4.

### 3.2 Traffic Classes

In an industrial environment, there are sometimes different types of traffic. Traffic tends to be event-based, other traffic is cyclical. In addition, industrial networks have traffic with strict QoS requirements, with less strict QoS requirements or even without specific QoS requirements. In general, any combination of traffic types can occur. For our model, we do not focus specifically on one category of traffic. We build our model on the assumption of knowing all traffic with all QoS requirements in our network. This requires that all traffic with QoS requirements has a higher priority than data traffic without QoS requirements. Our model is not optimized for configurations for specific QoS requirements to be achieved and analyzes the achievable delays for a fixed configuration. Therefore, an accurate mapping of traffic types to priorities within the network (i.e. the priority code point (PCP) value in the VLAN tag) is an input for the model and not limited thereto.

### 3.3 TSN Domain

As introduced in Section 3.1, the provider designs each network segment in an industrial network for a specific use case. The providers of the various network segments create a fixed configuration for the specific purpose. Such a network segment with a consistent TSN configuration is referred to as a TSN domain. At this stage, the machine vendor is only aware of the data traffic with QoS requirements in relation to the developed machine network. Therefore, the configuration of this TSN network not only contains resources for the reservation for all known traffic with QoS requirements, but also resource reservation for unknown data traffic with QoS requirements. This results in resource reservations and protection of QoS requirements in a TSN configuration that uses the same TSN mechanisms on all nodes within the TSN domain and requires all nodes in it for the TSN domain to be synchronized.

### 3.4 TSN Mechanisms

The technology, time-sensitive networking, is specified by a set of standards developed in the TSN Task Group of the IEEE 802.1. This series of standards enables standardized Ethernet networks. These offer time-deterministic transmission. Therefore, TSN is the decisive implementation for all Industry 4.0 and other convergent network scenarios. In this section, we present three TSN mechanisms that are required to fulfill the QoS requirements for the scenarios described.

By way of introduction, this selection is based on the current standardization status for the industrial TSN profile IEC/IEEE 60802 [7].

First, we start with time synchronization, as it is the most important mechanism for supporting distributed and synchronized applications. We then describe two mechanisms for protecting time-critical data traffic from the influence of lower-priority data traffic: time-aware shaper and frame preemption.

### 3.4.1 Time Synchronization: IEEE 1588 (PTP) and IEEE 802.1AS.

Synchronized applications require time synchronization between old end devices in the network. In the context of TSN, this is achieved via the precision time protocol (PTP) defined in IEEE 1588, or its industry profile IEEE 802.1AS [6]. Both protocols use grandmaster concepts and distribute the time with constant delay of the measurements between nodes for better compensation of errors. With PTP, the offset for time synchronization varies, but can achieve an accuracy of us over a distance of 60 nodes [7]. In Section 6 we present the effect of drifting clocks when they are not synchronized with one another. We observe a drift between the two clocks of several microseconds within minutes. Obviously, TSN domains can either be synchronized directly with their neighboring domain or not. In addition, IEEE 802.1AS offers the function for synchronizing with a foreign domain with so-called gPTP domains. FIG. 2 shows these three possible scenarios for the use of time synchronization. In scenario A), two neighboring TSN domains are synchronized among each other, whereas in scenario B) they have a different understanding of time. In scenario C), the middle domain passes on the knowledge of time synchronization between the upper and lower network segments. Thus, both use the same time domain A to synchronize their applications without interference in the time domain B. In scenarios A) and C), the virtualized PLC can take on synchronized control tasks.

### 3.4.2 Time-Aware Shaper (TAS): IEEE 802.1Qbv.

With the time-aware shaper (TAS), the IEEE has introduced a mechanism to provide a TDMA-like mechanism for Ethernet networks. Frames are classified based on the priority code point (PCP) value of their VLAN tag and sorted into queues. The queues open and close according to a configured schedule for transferring frames. The mechanism was originally introduced in IEEE 802.1Qbv [4] and is now integrated in IEEE 802.IQ [5].

FIG. 3 visualizes the TAS mechanism. An egress port provides eight queues, one for each of the eight priorities of the PCP field of the VLAN header. Thus, TSN supports up to eight traffic classes (TC). Based on a repeating gate control list (GCL), each egress port transmits the frames of the TCs in the time slots in which the port opens the queue. We refer to this open port for transmission as the TAS window. When multiple gates are open simultaneously, frames are selected by the strict priority mechanism, which selects the highest priority frame first. The priority list for a specific TAS window is defined as priowindow. We use this variable to analyze whether a TC uses a window exclusively or shares it with other priorities (i.e. exclusive gates and shared gates). For optimal operation, the TAS mechanism requires the neighboring nodes to be synchronized with one another. Otherwise, frames arrive with an unknown timing, which in the worst case leads to delays in forwarding. We discuss the direct influence of synchronized and unsynchronized nodes in Section 4.2.6.

### 3.4.3 Frame Preemption (FP): IEEE 802.1Qbu.

The frame preemption mechanism allows frames of certain priorities (express priorities) to overtake any other frame outside the preemptive priorities by temporarily pausing their transmission (i.e. frames that are not in the express priorities). This mechanism was originally introduced in IEEE 802.IQbu [3] and is now integrated in IEEE 802.IQ [5]. In addition, frame preemption also requires a change in the physical layer of Ethernet, introduced by IEEE 802.3br [2].

FIG. 4 shows two frames that arrive at switch a with a time delay. Both streams have different layer 2 priorities in the value of the priority code point (PCP) in the VLAN tag. The network is configured such that PCP 7 has the only explicit priority. The preemptive frame with PCP 6 arrives earlier and on a different port than the express frame with PCP 7. Therefore, the switch starts transmitting the PCP 6 frame first. As soon as the PCP 7 frame is ready for transmission, the switch anticipates the PCP 6 frame. This mechanism can only take into account frames that are 128 bytes and larger.

### 3.5 Deterministic Networking (DetNet)

With reference to Section 3.1, industrial networks comprise multiple independent machine networks (i.e. TSN domains). These combinations of ISN domains can either form a large layer 2 network or combine independent layer 2 networks to form a layer 3 network. TSN is specified for layer 2 and therefore handles all data traffic within the layer 2 domain. Deterministic networking (DetNet) is the technology for enabling time-critical data traffic across multiple layer 2 networks. DetNet comprises a series of standards defined by the IETF [15]. DetNet over TSN [32] specifies the transition between two TSN domains via a layer 3 forwarding node. In most cases, the specification requires deterministic forwarding delays and a stream for translation so that the TSN stream uses the correct layer 2 addressing within the next TSN domain (e.g. correct VLAN tag, and source and destination address). We also cover the similarities regarding the timing of layer 2 and layer 3 forwarding nodes in Section 4.2.

### 4. SYSTEM MODEL

In this section, we present our system model to analyze the best case and worst-case delays for TSN and DetNet networks. Therefore, we are introducing a generic forwarding model that fits to a TSN and DetNet node. Next, we introduce the delays independently of the transmission selection algorithm (TSA). We then discuss the TSA-dependent delay, i.e. the queuing delay, and evaluate its three different sub-delays. Finally, we discuss the sources and influences of jitter on network behavior.

### 4.1 Network Model

To derive a formal representation for our delay model, we first use a simple network model. The network consists of any number of nodes v that are connected via edges e. To represent a full-duplex Ethernet network, we use a directed graph and always two connections between two nodes to model and enable transmission in both directions simultaneously. Within this model, we do not differentiate between layer 2 and layer 3 networks, nor do we cover TSN domains. However, the following applies to our delay calculations: Time synchronization is important. Therefore, each node v is assigned a specific time domain. We do not introduce a formal representation here, so we can simply describe that two nodes are adjacent and synchronized with one another or not. Finally, we are aware of the complete TSN configuration (i.e. TAS and FP) within the plant network. There are any number of streams with QoS requirements within the network. We refer to the complete set of streams with QoS requirements as streams and the stream of interest as s. For each stream, we know its priority prios, its cycle time and the frame size bs. Furthermore, this is similar for every configuration. For the check, we know all the paths of the streams through the network. Therefore, streamse defines the number of streams on an edge. A basic requirement for IEEE 802.1 Ethernet networks is the forwarding of frames when the line is free, which means that a node v is never on the path of a stream s twice.

### 4.2 Forwarding Delay Model

FIG. 5 shows an abstract view of the forwarding, all delays and times are highlighted. This model takes into account TSN nodes that forward layer 2 frames and DetNet nodes that forward layer 3 packets. In the following sections, we address each of these delays and explain their effect within the worst-case delay model. For a flexible model that supports a mix of different network devices, each of these delays is defined and evaluated per node or edge.

4.2.1 Propagation Delay dprop

The propagation delay dprop defines the time for the first bit to traverse the entire line. This value is therefore dependent on the line length and is static per edge e.

4.2.2 Transmission Delay dtrans

The transmission time dtrans depends on the connection speed and the frame size. In this paper we only refer to the frame size of Ethernet (i.e. layer 2). However, when implementing the model, we also take into account the additional 20 bytes introduced by the inter-frame gap, preamble and initial frame boundary. This is for simplicity only, as layer 2 frame sizes are more typical in the context of TSN networks than layer 1 or layer 3 sizes.

Table 1 shows a selection of transmission delays for a few bit sizes at different connection speeds. This table is intended to provide a rough overview as a background to the dimensions of transmission delays, as the transmission delay is relevant for the interference delay and the blocking delay.

4.2.3 Processing Delay dproc

The processing delay dproc defines the duration within the forwarding node for processing the frame or packet. Both layer 2 and layer 3 forwarding nodes have this type of delay. This value varies depending on the node with its implementation, hardware vs. software, and the chips and software stacks used from node to node. However, we assume that this value is static per node v.

4.2.4 Interference Delay dinterference

A higher position in several domains on the same bridge potentially leads to more interfering streams. Depending on the configured QoS mechanisms, we can derive the worst case interference delay dinterference as explained in this section. dinterference defines the interference with the same or higher priority frames on an egress port of a bridge. The set of streams that can interfere with the stream of interest s is a subset of all streams e transmitted at the edge:

$$\text{?} \qquad ( 1 )$$

$$\text{?} \text{indicates text missing or illegible when filed}$$

The interference delay depends on the connection speed e of the edge
and is defined by the sum of all dtrans for the possible interferences, calculated in Equation 1:

$$\text{?} \qquad ( 2 )$$

$$\text{?} \text{indicates text missing or illegible when filed}$$

In the following, we derive the set interfrences,e based on QoS mechanisms on Edge e.

Strict priority: With the strict priority mechanism, all frames from the stream of interest that have the same and higher priority and can potentially cause interference. We model the subset of contradictory flows as follows:

$$\text{?} \qquad ( 3 )$$

$$\text{?} \text{indicates text missing or illegible when filed}$$

### Frame Preemption

As briefly introduced in Section 3.4.3, there are two categories of frames in frame preemption: 1) express frames, and 2) preemptive frames. Depending on the assignment of a current to one of these two classes, the interference calculation is different. If the desired stream is part of the express category prioexpress, the stream can only interfere with other express streams. Strict priority is the mechanism used to decide between different streams in the express category. We model the subset of streams with a possible interference as follows:

$${interference}_{\text{?}} = \{ c \vert c ∈ {streams}_{e} ∧ {prio}_{e} ∈ {prio}_{express} ∧ {prio}_{e} \geq {prio}_{s} \} \qquad ( 4 )$$

$$\text{?} \text{indicates text missing or illegible when filed}$$

If the stream of interest is not part of the express priorities prioexpress, it is part of the preemptive priorities priopreemptible. In this case, all express streams can preempt the stream of interest and therefore cause an interference delay. Within the preemptive priorities, the strict priority selects the next stream for transmission. Therefore, we model the subset of streams with possible interferences as follows:

$${interference}_{\text{?}} = \{ c \vert c ∈ {streams}_{e} ∧ ( {prio}_{e} ∈ {prio}_{express} ∨ ( {prio}_{e} ∈ {prio}_{preemptible} ∧ {prio}_{c} \geq {prio}_{s} \} \qquad ( 5 )$$

$$\text{?} \text{indicates text missing or illegible when filed}$$

Time-aware shaper. With the TAS mechanism, only the switch transmits a subset of priorities depending on the TAS configuration. Therefore, we only consider the subset of old streams with the highest priority in priowindow. Additional streams that could cause interference must have the same or a higher priority:

$${interference}_{\text{?}} = \{ c \vert c ∈ {streams}_{e} ∧ {prio}_{e} ∈ {prio}_{window} ∧ {prio}_{e} \geq {prio}_{s} \} \qquad ( 6 )$$

$$\text{?} \text{indicates text missing or illegible when filed}$$

4.2.5 Blocking Delay dblck

The blocking delay defines the duration of a frame that blocks a stream s at the edge e, even though it has a lower priority. These delays depend on the TSN mechanisms configured on this node. With strict priority as the transmission selection algorithm, Ethernet switches select the highest priority for the frame that is ready for transmission.

However, if the switch has recently started transmitting a lower priority frame, even though the higher priority frame is ready to be sent, this causes a delay for high priority traffic, possibly in the form of a maximum frame size. Therefore, IEEE 802.1 introduced the two mechanisms TAS and frame preemption (FP) to reduce the impact on critical traffic.

$${d}_{{blck}_{\text{?}}} = \{ \begin{matrix}0 bytes & TAS : exlcusive gates \\ 1 , 522 bytes & TAS : shared gates \\ 127 bytes & FP : s ∈ express \\ 1 , 522 bytes & FP : s ∈ preemptible \\ 1 , 522 bytes & Strict Priority\end{matrix} \qquad ( 7 )$$

$$\text{?} \text{indicates text missing or illegible when filed}$$

Therefore, we represent the maximum blocking time dblck to denote a lower priority frame depending on the mechanism used in Equation 7. Within this formula, we assume a maximum frame size of 1,522 bytes, as this is the maximum in standard IEEE Ethernet networks. However, IT networks often use jumbo frames (e.g. for video data) with a size of 9,022 bytes or even jumbograms with a size of 65,597 bytes. Therefore, the size of 1,522 bytes in Equation 7 is a placeholder for the maximum frame size at the edge e.

4.2.6 Gate Delay dGate

The TAS mechanism holds a frame in the output queue when the gate is closed, even if there is no other traffic. Based on the network model in Section 4.1, the GCL configuration is known on each node. The gate delay dgate defines the duration, the node does not forward a stream as the gate for this stream is closed. If no TAS mechanism is configured, the gate delay is set to 0. For each priority, the transmission window in the GCL is open for the duration dwindowprio,e at the edge e, it opens at time topenprio,e and closes at tcloseprio.e. The cycle time CT defines the repeating patterns for the gate open and gate close events.

$${d}_{{gate}_{\text{?}}} = CT - {d}_{{window}_{prio , e}} \qquad ( 8 )$$

$$\text{?} \text{indicates text missing or illegible when filed}$$

Equation 8 applies to the unsynchronized scenario, where we do not know the exact arrival times of streams. In the synchronized scenario, dgate depends on the time of a frame which is ready for transmission at tenq. A frame can either be too early in a cycle and wait for topen. Alternatively, a frame does not fit into the cycle, in particular if it is too late for transmission or if there is too much interference within the remaining open window in which transmission is possible.

$${d}_{{gate}_{\text{?}}} = \{ \begin{matrix}{t}_{{open}_{prio , e}} - {t}_{{enq}_{\text{?}}} & ( {t}_{{enq}_{\text{?}}} < {t}_{{open}_{prio , e}} ) \\ & ( {t}_{{close}_{\text{?}}} > ( {t}_{{enq}_{prio , e}} + \\ {t}_{{open}_{prio , e}} + CT - {t}_{{enq}_{\text{?}}} & {d}_{\text{?}} + {d}_{{blck}_{\text{?}}} + \\ & {d}_{{interference}_{\text{?}}} ) \% CT ) \\ 0 & otherwise\end{matrix} \qquad ( 9 )$$

$$\text{?} \text{indicates text missing or illegible when filed}$$

It is important to note that Equation 9 does not directly assume a forwarding of a frame to tenq. We believe that frames on the egress port can be delayed by data traffic of the same and higher priority (cf. dinterference in Equation 2). More and more, a lower priority frame can block the stream of interest for the duration of dblck (cf. Equation 7).

### 4.3 Jitter Model

So far, the model contains static delays. However, Ethernet networks are not static at all. The biggest difference in behavior for synchronized networks is based on interference and blocking delays, as Table 1 shows the individual transmission delays. In addition, the gate delay for non-synchronized scenarios also has a major influence. These two effects are discussed in Section 5.1. There are two other types of jitter within a TSN network, which we emphasize here as follows: A) time synchronization jitter and B) forwarding jitter.

Firstly, the time synchronization between two nodes is not stable over time. Therefore, the TAS ports do not open across the network in perfect cycles, but with small deviations. Depending on the time synchronization mechanism, this type of jitter varies. Protocols such as NTP have a lower accuracy than those such as IEEE 1588 (PTP) or IEEE 802.1AS. The requirements document for the industrial TSN profile IEC/IEEE 60802 specifies a maximum jitter of 1 μs across 64 nodes in the network. Therefore, the current version of the IEC/IEEE 60802 specification requires the use of IEEE 802.1AS.

All components, such as PHY or switching chip, have a best-case and a worst-case behavior. The forwarding jitters vary depending on the quality of the hardware component and the software stacks for software forwarding. We therefore introduce a jitter definition for each of these delays: propagation jitter: Jprope, transmission jitter: jtranse and processing jitter: jprocv.

In Section 6.3, we analyze the jitter and discuss its distribution. Compared to the influence of the interference delay and blocking delay, all jitter values in this section are negligible, as are those in the range of a few nanoseconds to a microsecond, compared to a few microseconds and up to several milliseconds. However, we aim to obtain a complete model and thus present our implementation that covers all these types of jitter.

### 5. BEST AND WORST CASE DELAY MODEL

This section builds the delay model for the complete factory network. Equipped with the complete topology, the configuration and streams with QoS requirements of which are described in Section 4.1, the model generates a best-case and worst-case delay for each stream. This model does not limit the TSN configuration and topology, but analyzes the individual delays per node and edge. The aim of this model is to calculate an expected arrival window for each stream on each node in the network. This arrival window darriv is calculated as the difference between the most favorable and least favorable delay. FIG. 6 visualizes the increasing arrival window in gray over the distance within the network. The topology is a simple line topology with the best latency behavior, visualized here in green. The worst-case latency increased independently for each cycle and is shown in red. Within this cycle, the network is in the gray range. At each node in the network is the difference between best case and worst case, because a stream denotes the arrival window darriv of this specific stream. Later, in Section 7, we use this arrival window for analysis to detect potential congestion in worst-case scenarios and to identify inefficient TSN configurations.

We start the presentation of the model with a basic model. We calculate the best-case and worst-case behavior in Section 5.1. We introduce the effects of changes in connection speed into our model in Section 5.2. Finally, we add congestion control and detection to our model in Section 5.3.

### 5.1 Basic Delay Model

The delay of a stream s on the forwarding node v and the edge e is defined as the sum of all delays shown in FIG. 5:

$${delay}_{\text{?}} = {d}_{{prop}_{\text{?}}} + {d}_{{trans}_{\text{?}}} + {d}_{{proc}_{\text{?}}} + {d}_{{queue}_{\text{?}}} \qquad ( 10 )$$

$$\text{?} \text{indicates text missing or illegible when filed}$$

The propagation and processing delays are static values for the connecting or forwarding nodes. The transmission delay depends on the connection speed and the frame size.

To complete this basic model, represented by equation 10, we define the queue delay as follows:

$${d}_{{queue}_{\text{?}}} = max ( {d}_{{gate}_{\text{?}}} , {d}_{{blck}_{\text{?}}} ) + {d}_{{interference}_{\text{?}}} \qquad ( 11 )$$

$$\text{?} \text{indicates text missing or illegible when filed}$$

If the TAS mechanism is configured on the egress port and the frame, it must wait for the gate to open; there can be no blockage due to delay. Therefore, we can always calculate the maximum of the two values and derive a correct model, as shown in Equation 11. In the best case, a stream does not interfere with any other stream or is blocked by other data traffic. That is why we specify: (dinterferences,e and dblcks, e are set to 0. Likewise, if no TAS is configured, we set dgates, e to 0. Otherwise, we apply Equation 8 or Equation 9, depending on the synchronization state. In fact, in the unsynchronized scenario, the gate delay dgates,e is set to 0 in the best case.

In the best case, we also subtract the jitter for the difference in the delay components. For this correction, we assume an optimum behavior of old components on the forwarding path. The sum of all forwarding jitters is defined as follows:

$${j}_{{prov}_{\text{?}}} + {j}_{{trans}_{\text{?}}} + {j}_{{proc}_{\text{?}}}$$

$$\text{?} \text{indicates text missing or illegible when filed}$$

If the TAS mechanism is configured, we also assume that the gate delay dgate is reduced by jtimesyncv. To calculate the worst-case behavior, we need to apply Equations 2 and 7. Similar to the best case, we need to calculate the port delay delay dgate, but this time with the worst values dinterferences and dblck. In addition, we add the sum of old forwarding jitters. If the TAS mechanism is configured, we increase dgate by/timesyncv. As a result, this model calculates the best-case delay and the worst-case delay. The arrival window darriv indicates the difference between the two delays. FIG. 6 shows a small example structure of this arrival window.

### 5.2 Effects of Connection Speeds

In our delay model, we track the size of all streams in bytes bs. In addition, the topology model shows the connection speed on each link. Therefore, the model is able to process any kind of changes in connection speed across the entire network for industrial scenarios. This is a very important requirement, as sensors and actuators often only have 100 Mbit/s connections, but the backbone runs at 10 GB/s, for example. As shown in Table 1, these different connection speeds result from a different transmission duration dtrans and thus specific interferences and blocking delays. FIG. 6 shows this change in connection speeds with the different inclination angles in the envelope curve.

### 5.3 Influence of Cycle Times

There are two types of cycle times within a TSN network. On the one hand, there is the application cycle time, with which an application transmits cyclical data. And on the other hand, in the TAS mechanism, the GCL works with a given network cycle time. The time, in combination with the frame size, defines the bandwidth required by the application. The network cycle time in combination with the GCL window duration defines the time for possible throughput. If the forwarding node does not use the TAS, the throughput is limited by the connection speed. Even if no TAS is configured and we have do not have a network cycle time, we still always have an application cycle time.

Based on our assumption, each TSN domain has a static and an individual configuration, so we cannot assume that the cycle time and the network cycle time of the application are the same. Such changes in cycle time either cause more frames of a particular stream within a cycle or fewer. FIG. 7 shows an example of the change in the network cycle time from one node to the second. The first node (left) has a cycle time of 1 ms and the second node of 5 ms. Therefore, five frames of the same stream from the first node will always be present within the next cycle. To avoid congestion within the network, the configuration on the second node must be able to transmit all five frames. The same applies to the end device with an application cycle time when sending to a network with TAS configuration. Similarly, the arrival window darriv of a stream can be larger than the cycle time on the next node and this leads to a multiple of frames for a stream within the cycle.

To cover the need for increased bandwidth per stream, we calculate three factors f, which we use to increase the reserved bandwidth. First we cover the increasing arrival window darriv and calculate farrival. We calculate the ratio between the arrival window and the new cycle time CTv. Next, we round up this result to always allow the full stream to be in one of the possible cycles:

$${f}_{arriv} = ⌈ {d}_{arriv} / {CT}_{v} ⌉$$

Secondly, the change in cycle times is similar and is defined by fCT. If the cycle time on the second TSN node increases (i.e. it operates more slowly), several original cycles are completed before the cycle continues and the second node is completed. Therefore, the second TSN node needs time to process more frames of the same stream than between the two cycle times, depending on the ratio:

$${f}_{CT} = ⌈ {CT}_{v} / {CT}_{v - 1} ⌉$$

In the scenario with decreasing cycle time on the second TSN node (i.e. working faster), we need to assume the frames of the stream in every cycle, as we are not modeling a stream in which it should be present, e.g. every second cycle. Therefore, this has no influence on the bandwidth reservation.

Finally, we calculate the factor based on the difference between application cycle time and network cycle time fapp. Similar to the previous scenario, we only cover the case that the network is cyclical, i.e. time CTnet is slower than the application cycle time CTapp:

$${f}_{app} = ⌈ {CT}_{net} / {CT}_{app} ⌉$$

With these three values, the model increases the expected worst-case bandwidth with:

$${b}_{s , v} = {b}_{s , v - 1} \cdot {f}_{arriv} \cdot {f}_{CT}$$

And at the first TAS-configured node along the stream path s, the model increases the bandwidth with:

$${b}_{s , v} = {b}_{s , v - 1} \cdot {f}_{app}$$

### 6. ASSESSMENT

During the evaluation, we analyze various scenarios in the network and discuss the observed behavior. The aim of the evaluation is to emphasize the applicability of our model to cover the following: a diverse mix of TSN configurations. Furthermore, the evaluation shows the feasibility of the model with a simple implementation. We structure our evaluation as follows. First, we present our measurement setup and methodology. Secondly, we evaluate said measurement setup and methodology, in particular the effect of drift between non-synchronized clocks. Thirdly, we analyze the capabilities of our measurement setup, i.e. the jitter of real TSN devices. We then focus on specific elements in our model, such as synchronized vs. unsynchronized behavior and interference and blocking delays due to cross traffic. Next, we will discuss the changes in network cycle times.

### 6.1 Setup and Methodology

We evaluate everything with measurements on standard TSN hardware. For all measurements, we have a line topology with four devices: one transmitter “node 0” and three forwarding nodes. Each of these devices is capable of inserting a timestamp in hardware into the frame on the ingress and egress port of the node. Therefore, we can track each frame across the network and then analyze the behavior based on packet captures.

FIG. 8 shows the topology and three different paths for data traffic. For each measurement, we have measurement traffic with 500 byte frames from “node 0” to “node 3”. In addition, cross traffic on paths two and three. This cross traffic is implemented as an Internet mix (IMIX) and consists of three streams with the frame sizes: 64 bytes, 570 bytes and 1522 bytes. All diagrams only show existing measurement traffic and no cross traffic. The duration of each measurement is between 25 minutes and five hours to show the stability of the results in terms of clock drift and jitter.

In general, we have two forms of visualization. Firstly, we plot the measurement curve over time. This visualization represents the trend over time, i.e. either the effect of drifting clocks (continuous increase and decrease of values), jitter (if there are peaks) or stability (horizontal lines). Secondly, we present the measurements on one port per node base. With this form of visualization, we create a visualization that is compatible with the arrival window.

An important note for all measurements in this section is that the timestamps are based on the internal time of each node. The nodes are synchronized via IEEE 802.1AS. Therefore, the results contain an inaccuracy of a few nanoseconds due to this synchronization.

### 6.2 Time Synchronization

FIG. 9 visualizes the effect of non-synchronized nodes in the network. The y-axis represents the offset to the transmitter in microseconds and the x-axis the duration of the measurement. The four times represent one measuring point per device in the topology. In FIG. 9a, all nodes within the network are synchronized with IEEE 802.1AS and we observe stable behavior. The accuracy of the time synchronization is within a few nanoseconds. Therefore, we observe no deviation during the measurement, and the measured difference can be related to the forwarding time of the frames. In particular, the transmission time of a 500 byte frame over a 1 GBit/s connection is approximately 4 μs, and the switches have a processing delay of between 1 and 2 μs. In comparison, in FIG. 9b only “node 1” is synchronized with the transmitter and “node 2” is synchronized with “node 3”. We observe that the timebase of the last two devices is drifting away from the first two devices. However, the time behavior in between is the same and each “node 0” and “node 1” and “node 2” and “node 3” remain stable. This scenario is the behavior that two non-synchronized TSN domains will have.

### 6.3 Jitter

In applications where time-critical conditions are present, low jitter is crucial for correct network behavior. High jitter causes different behavior from cycle to cycle, e.g. interference with other traffic or in the calculations on the controllers and devices. Our model therefore includes the jitter components within the network and calculates the best-case and worst-case behavior. FIG. 10 visualizes the measurements with one measurement at “node 0” and two measurements at the other three nodes. FIG. 10a visualizes each of the inserted timestamps everywhere as a measurement run with the timestamp “node 0” as a reference. In fact, FIG. 10a uses the same measurement as FIG. 9a and adds the view of ingress and egress timings. This diagram clearly shows stable operation without interfering with other network traffic. However, you can already see that the lines at the top are thicker than those at the bottom, which indicates jitter. To analyze the jitter within the forwarding process, FIGS. 10b to 10d show detailed views. Firstly, FIG. 10b shows the jitter for the total end-to-end latency. We subtract the timestamp “node 0” from the output timestamp of each node and calculate the jitter in it from the resulting series of delays. We can see that the jitter increases as the distance increases (i.e. “node 1” is closer to “node 0” than to “node 3”). We also observe a wider distribution of jitter over longer distances in the network. Secondly, FIG. 10c visualizes the jitter of the processing time. To calculate the data set, we subtract the input timestamp of each node from the output timestamp of the same node. The distribution is the same on every node as it is the same hardware. Furthermore, the jitter depends on the processing time and is in the range of just 10 ns. Thirdly, FIG. 10d shows the difference between the output and input of the two neighboring nodes. This diagram represents the jitter in the transmission delay. Again, their distribution is similar on all paths and is in the range of 30 ns.

### 6.4 Connection Speeds

A trivial component within this model is the transmission time of each stream per edge. FIG. 11 shows the delays between four nodes in a line topology. In this scenario, the connection speed between “node 0” and “node 1” and between “node 2” and “node 3” is 1 Gbit/s and only 100 Mbit/s for the connection between “node 1” and “node 2”. As shown in FIG. 11a, the delays are very stable over the measurement interval of 25 minutes. FIG. 11b shows the exact measurement in a per-hop view. This number clearly shows the reduced connection speed between “node 1” and “node 2” with the steeper edge and thus the increased delay. The visualized time stamps have their reference point on the output side of each node. Therefore, any delay to the node beforehand includes the propagation delay of the line (the same applies to each connection), the transmission delay for a 500 byte frame (which depends on the connection speed) and the processing delay (which is constant and a static value of 1 μs for all nodes). Based on these components, the model presented in Section 5 results and in the best case the delay is 4.1 μs for the 1 Gbit/s connections and 41 μs for the 100 Mbit/s connection. There is no traffic other than the measurement of data traffic within this configuration. The worst-case delay derived from the model requires only the addition of all jitter components, as shown in Section 4.3 and evaluated in Section 6.3.

### 6.5 Time-Aware Shaper

In this section, we present the assessment of the behavior of the TAS. FIG. 12 shows the results used for discussions in this section. We used the same TAS configuration for both the synchronized and unsynchronized measurements. The “node 0” node sends a frame at the beginning of the interval and each of the following three nodes open their gate for the measurement traffic for 40 μs. For each node, we postpone the time to open the gate by 30 μs. The measurement stream has a size of only 500 bytes, the stream needs the first 4 μs and at the next node about (30-5) μs (including other delays such as the processing delay). For a detailed analysis, all figures show the receive time (i.e. rx) and transmit time (i.e. tx) of each forwarding node.

In the synchronized scenario (see left two figures in FIG. 12), all four nodes in the network are synchronized with on another. FIG. 12a shows this static behavior with a waiting time of 25 μs (difference between rx and tx value of a node) during the entire process of the measurement duration. FIG. 12c visualizes the same measurements on a per-node basis and again covers two timestamps per forwarding node. This figure shows the consistency of latency behavior over time, as all streams use the same amount of time for transmission over the network. In the unsynchronized scenario, the nodes “node 0” and “node 1” are synchronized with one another, and “node 2” and “node 3” are synchronized with one another, but not “node 1” to “node 2”. FIG. 12b uses a different scale as the envelope curve than the synchronized figure, because the transmission increases by more than the cycle time. The red line (“node 2-rx”) visualizes the drift between the two time domains. At the beginning of the measurement, both time ranges have a similar time behavior and drift away from one another. The three upper times (“node 2-tx”, “node 3-rx” and “node3-tx”) indicate that increased queuing occurs after about 60 minutes within the measurement. This queuing effect is clearly visible in FIG. 12d. Only a small subset can be transmitted within the first cycle of streams. This is because with the increased time difference, frames between “node 2-rx” and “node 2-tx” must be queued.

### 6.6 Interference and Blocking Delay

In this section, we analyze the effects of interference and blockages caused by other streams. In addition, we compare the measured results with the arrival windows calculated by the worst-case model. FIG. 13 shows three different settings for this analysis. For each of these three scenarios, we model the cross traffic with IMIX. We inject the cross traffic only on nodes two and three in order to have a stable reference behavior on the first node. First we discuss the interference with streams of the same and higher priority. Furthermore, we analyze the blocking delay for either strict priority or frame preferences.

### 6.6.1 Interference Delay

FIG. 13a shows the input and output of the times on all nodes in the network for all frames. The thick green and blue bars indicate the deviation in the forwarding to the third node to the second. FIG. 13b shows the same measurement sequence of a pre-hop view in light gray. In addition, this figure also visualizes the transmission envelope calculated with our model in green and red. As we feed in the entire cross traffic unsorted and unsynchronized, the measuring current uses the entire transmission envelope. With knowledge of all streams, however, the model correctly predicts the worst case (see red line). In Appendix A.2, we present measurements with incorrect knowledge about the streams with QoS requirements.

### 6.6.2 Blocking Delay

For the analysis of blocking delay (i.e. collision with lower priority traffic), we start with the strict priority scenario in FIG. 13c and FIG. 13b. We observe regular delays with a maximum of 12 μs per node, which indicates blocking by a maximum Ethernet frame. The evaluation shows that the worst-case model correctly predicts the blocking time in our scenario. FIGS. 13e and 13f illustrate exactly the same setup, but configured with frame preemption. The measuring stream is in the express category, the cross traffic is preemptive. We observe only small delays of up to 1 μs per node in FIG. 13e. As shown in Table 1, this behavior corresponds to the blocking that is caused during frame preemption in the worst case. Therefore, the envelope curve in FIG. 2 is much thinner at 13f and the jitter in the arrival of the stream is also reduced with frame preemption.

### 6.7 Changes to the Network Cycle Time

In Section 5.3, we define the increased bandwidth requirements for changes in cycle times between two nodes. Furthermore, in Section 4.2.6, we derive the worst-case delay for streams with the TAS mechanism. Therefore, we assess these two elements of our models in this section. FIG. 14 shows the measurements within a topology and in the configuration scenario similar to the node shown in FIG. 7, “node 0” and “node 1” have a cycle time of 1 ms, while the nodes “node 2” and “node 3” have a cycle time of 5 ms. FIG. 14a visualizes the result with the transmission time as a reference and visualizes the delay of each stream for each of the next hops. Each of the values is the transmission time on each node and therefore after the TAS gate. So no significant delay is visible on the nodes “node 0” and “node 1”, only the delays to be expected in the best case. The division into five different delay clusters on “node 2” represents different clusters of buffer delays. However, only as “node 2” forwards the frames for the measuring stream every 5 ms, receives them every 1 ms, some frames are forwarded directly (with some interference), and some frames are buffered for 4 ms. Referring to Equation 9 (the measurement is based on a synchronized topology), we can calculate the gate delay for each of the five possibilities. We derive a worst-case gate delay as:

$${d}_{{gate}_{\text{?}}} = {t}_{{open}_{price}} + CT - {t}_{\text{?}} = 0 ms + 5 ms - 1 ms = 4 ms$$

$$\text{?} \text{indicates text missing or illegible when filed}$$

### 7. USE CASES FOR THE MODEL

In this section we present the use of the model defined in Section 5 within a complete network. As described in Section 5.1, we do not cover the exact order of streams per node from their arrival times as the model calculates the interference amount of the streams. We can therefore calculate the delays for each edge and node individually. However, we increase the bandwidth for all streams with an arrival window greater than the cycle time or different cycle times between two nodes. Therefore, we need to recalculate the delays for all nodes and edges to which this bandwidth belongs. This recalculation potentially causes recursive recalculations. The upper limit for the number of recalculations is the number of ports in the network, as we have a directed graph without loops. This upper limit is based on the assumption of loop-free and directed graphs, which are a basic principle of IEEE 802.1 Ethernet. Our model is still redundancy-capable, based on loop protocols. In fact, for every IEEE Ethernet redundancy, each stream only leaves each port once.

We are opening up the implementation of our model. The code in this repository implements the model introduced in this white paper and the use cases described in the rest of this section as an exemplary use of the model. In the following sections, we present the four use cases for the model we specified in the introduction (i.e., end-to-end latency, congestion detection, identification of inefficient transitions, and network debugging), with further details and examples. In Appendix A, we provide additional information on the specific use of the open source code.

### 7.1 End-to-End Latency/Application

### Requirements

The main motivation for the best-case and worst-case model is our first use case, the calculation of end-to-end latencies and verification of application QoS requirements. To apply the model to this usage, we run it with a given configuration of the network and a series of streams with QoS requirements. These streams can differ in terms of priorities and QoS requirements. In the first step, we calculate the latencies per hop for all streams. Next, we recalculate all delays that are subject to increased bandwidth requirements for some streams (cf. Section 5.3). In the last step, we add all delays individually via old nodes and edges for each stream. The result is a best-case and a worst-case end-to-end delay per stream. These two values are used to validate the application requirement for arrival jitter (i.e. arrival time and maximum delay). We present an example of this calculation for this use case in Appendix A.1.

### 7.2 Analysis of Congestion/Bottlenecks

In the second use case, we analyze bottlenecks in the topology and setup. Such bottlenecks can lead to links becoming saturated, resulting in packet loss due to overloaded buffers. In Section 5.3, we introduced the increased bandwidth per stream for use in the delay calculation. After calculating the best-case and worst-case delays, we compare the calculated bandwidth requirements with the available resources. For frame preemption and strict priority, the overall limit is the connection speed, and TAS artificially reduces the available bandwidth per priority. Finally, we calculate the worst-case saturation of a link based on the cycle time and compare the required buffer sizes with the sizes available in the hardware. This results in an occupancy evaluation per edge in our topology. Appendix A.2 presents a sample calculation for this use case.

### 7.3 Identification of an Inefficient Domain

### Transitions

The model presented in this paper is the basis for planning and optimization within TSN networks with various configurations and time synchronization. Our paper does not introduce an algorithm or configuration optimization for scheduling. However, the model identifies inefficient configurations and highlights the benefits for reconfiguration. The efficiency of a transition of the worst-case delay refers to the potential that is introduced on this edge. In the first two use cases, we calculate all individual delays per node and switch and all buffer requirements per port. We can then determine each transition between two nodes based on efficiency. We provide an example calculation for the ranking of efficient configurations in Appendix A.3.

### 7.3.1 Network Debugging

Finally, we present the network debugging use case. Searching large networks for unexpected delays is complex and time-consuming. Therefore, we see network debugging as the main advantage of this model. However, the quality of debugging depends on the devices used in the network, as these have different functions and functional elements for analysis. This section describes debugging based on commercially available industrial products from our industry partner. Our research shows that other commercially available devices in the industrial and IT sectors also offer similar features.

For an initial analysis, we calculate all delays and connection requirements based on the topology, configuration, and streams that our model will use. Next, we start the debugging by comparing the actual connection saturation with the calculated saturation. Typically, the network infrastructure aggregates the saturation either for each ingress port or even for each port per traffic class individually.

In a second analysis, we compare the calculated delay envelope curve with the actual behavior in the network. The shared network infrastructure has the ability to set up port mirroring. This function allows us to copy all data traffic from one egress port of the forwarding nodes to a second port. Next, we capture the data traffic for a few cycles and can analyze the behavior of cyclic streams. Knowing the cycle time for each stream, we calculate the value of the arrival time using the cycle time. This result allows us to generate a histogram with the offset for each stream within the cycle. Finally, we compare the observed distribution with the calculated distribution. This analysis shows the degree of accuracy for the stream checked.

We apply both debugging analysis methods to each egress port individually, which leads to a linear increase in effort for each additional port in the network. Since the first method is less complex and easier to automate, we use it as the first check for performance on the network. Later we use the capturing method. On old ports we observe high saturation values or have streams with failed QoS requests. This simplifies the identification of reasons for delays at these ports.

### 8. CONCLUSION

IEEE TSN and IETF DetNet are a promising combination of mechanisms to create a common deterministic factory network. However, the use of different TSN mechanisms in TSN domains makes it difficult to determine QoS guarantees for TSN interdomain traffic. Previous work has avoided this problem by assuming a homogeneous series of mechanisms and a uniform schedule and time source for all domains. For example, all nodes would use a common time, synchronization or perfectly coordinated TAS schedules would be configured. In practice, however, this cannot be assumed for many cases because the combination of machines and lines that are assembled are configured individually.

In this paper, we present a model for calculating best-case and worst-case delays for heterogeneous industrial network architectures based on TSN. In particular, our model is able to deal with existing static TSN configurations of individual machine networks and a lack of time synchronization between them. We also look at jitter, which is caused by the network infrastructure and is often neglected.

First, we analyze the impact of individual TSN mechanisms for mixed time-critical and non-critical traffic in synchronized and non-synchronized scenarios. Secondly, we use these individual assessments and construct a best-case and a worst-case model. With these models, we cover the influences of different configurations across TSN network domains, e.g. changes in network cycle times and potential overload assessments in worst-case scenarios. We highlight four specific use cases of this model with different network deployment and operation scenarios in typical TSN. Finally, we evaluate the applicability and accuracy of our model in a real-world test environment with actual industrial-grade TSN hardware and TSN configuration, which is novel in research. Our evaluation shows that the model can accurately predict the behavior of real industrial TSN network devices. The model therefore makes it possible to calculate the achievable QoS guarantees across different TSN domains and to determine whether they are sufficient for the operation of a particular industry and are both acceptable and reliable for the applications.

### A Application of Use Cases

This section is an informal extension to the source model presented in this paper to explain the functionality of the various use cases we presented to the public in Section 7.

In the examples in the appendix, we use the topology as visualized in FIG. 8. Unless otherwise specified, all devices in this topology are synchronized with one another.

### A.1 End-to-End Latency/Application

### Requirements

In this section, we present the use case for deriving the end-to-end delays and calculating the arrival window at each node in the network.

This means that we have calculated all the approaching arrival windows visualized in Section 6. The information about the best-case and worst-case end-to-end delays makes it possible to check the QoS requirements of the application.

For our demonstration, we use the topology in FIG. 8 and have set the streams in Table 2.

The calculation of end-to-end delays starts with the following

### Command:

python main.py a1 arrival_window_calculation

| port | best-case [ns] | worst-case [ns] |
|---|---|---|
| node 0-tx | 4135 | 17511 |
| node 1-rx | 5105 | 18541 |
| node 1-tx | 44165 | 56511 |
| node 2-rx | 45135 | 57541 |
| node 2-tx | 84165 | 114297 |
| node 3-rx | 85135 | 115327 |
| node 3-tx | 124165 | 154297 |

### A.2 Analyzing Congestion/Bottlenecks

In this section, we present the use case for identifying potential overloads within the network. In general, congestion occurs when traffic rates exceed the connection speed. In addition, with the TAS mechanism, the gate entries artificially reduce the possible throughput on a link. For larger scenarios, it is still easy to analyze the traffic paths and decide on the frame sizes to see if this setup can work. However, as we presented in Section 5.3, multiple frames of the same stream in the same cycle must be expected with different TSN configurations. We have therefore created a scenario to analyze this overload. For our demonstration, we use the topology in FIG. 8 and the stream set in Table 2. However, we reduce the cycle times for streams 2 to 7 to 330 μs. In our repository, this setup is shown behind the topology “a2”. The analysis of possible congestion in the scenario described above starts with the following command:
python main.py a2 congestion_identification

| Port | occupancy [%] |
|---|---|
| node 0-tx | 1 |
| node 1-tx | 1 |
| node 2-tx | 233 |
| node 3-tx | 233 |

In order to visualize the effects of congestion, we have transferred this TSN configuration to the measurement setup. FIG. 15 shows the results.

### A.3 Identification of Inefficient Transitions

In this section, we present the use case for identifying inefficient transitions between two neighboring TSN nodes based on their TSN configuration and the influence of other traffic with QoS requirements. For this purpose, we track each worst-case delay increment between two nodes during the calculation of the worst-case model. Afterwards, we can arrange these delay increments in descending order and identify them as the transitions with the greatest potential for improvement.

For our demonstration, we use the topology in FIG. 8 and the stream that was set in Table 2. As this is a small example, we will keep it for now and follow the calculations manually. We have already noticed a possible high interference delay in the model. In addition, we deactivate the time synchronization between “node 1” and “node 2”. The analysis therefore reveals another major influence on the worst-case delay. In our repository, this setup is what is behind topology “a3”.

The analysis of the inefficient transitions for the scenario described above starts with the following command:
python main.py a3 inefficient_transitions

The open source model outputs the following:

| transition | delay [ns] |
|---|---|
| node 2-t* | 1004357 |
| node 3-tx | 91369 |
| node 1-tx | 37970 |
| node 0-tx | 17511 |
| node 1-rx | 1030 |
| node 2-rx | 1030 |
| node 3-rx | 1030 |

This table shows a sorted view of the transitions, based on their efficiency. The three “rx” delays indicate the processing delay. In a larger topology with different devices, these will not all be the same. The four “node 0” delays visualize the delays in the output from a forwarding node, i.e. queue delay dqueue. Obviously, “Node 2-tx” has the highest delay as unsynchronized data traffic is forwarded with a TAS configuration.

“node 3-tx” also has a higher worst-case delay compared to “node 1-tx”. This difference in the delays leads to interference and thus to delays on “node 3”, although both are previously synchronized to the nodes.

### Translation of the Titles of the Figures:

FIG. 1: Exemplary ICS network architecture

FIG. 2: Possible setups for time synchronization: A) all synchronized, B) no synchronization between domains, and C) communication via a non-synchronized domain

FIG. 3: Time-aware shaper (TAS): IEEE 802.1Qbv

FIG. 4: Frame preemption (FP): IEEE 802.1Qbu

FIG. 5: Forwarding delay model

Table 1: Layer 2 transmission delay for a minimum IEEE Ethernet frame or minimum preemptive frame fragment (64 bytes), maximum preemptive frame fragment (127 bytes), a maximum IEEE Ethernet frame (1,522 bytes), a maximum IP jumbo frame (9,022 bytes) and a maximum IP jumbogram (65,597 bytes) at different connection speeds

FIG. 6: Visualization of the calculated arrival window of the presented model for a fictitious setup

FIG. 7: Change of the cycle time from 1 ms on the left to 5 ms on the right

FIG. 8: Setup for evaluation; each node uses the TAS mechanism; the window from each node to the other is opened for 30 μs; next, the start of the TAS window in the path is postponed by 40 μs; the TAS is open for priorities 5, 6 and 7

FIG. 9: Synchronized and non-synchronized traces through the network in a per-packet view; measurement duration: 60 minutes; 20 images per second; 512 bytes per frame
(a) all nodes are synchronized to the sender “node 0”
(b) only “node 1” is synchronized with the sender, “node 2” is synchronized with “node 3”

FIG. 10: Jitter analysis within a line topology of four devices; each measurement is based on the internal time of the devices and therefore contains the jitter of the time synchronization/time synchronization
(a) timestamp for all incoming data and egress ports
(b) end-to-end jitter: jitter measured between “node 0” and all three nodes in the line
(c) processing jitter: jitter measured between ingress and egress each of the three forwards between the nodes
(d) transmission jitter: jitter measured between output and ingress of two neighboring nodes

FIG. 11: Delay measurements in a line topology with two different connection speeds; 100 Mbit/s between “node 1” and “node 2”, and 1 Gbit/s connections between “node 0” and “node 1” and between “node 2” and “node 3”

FIG. 12: Synchronized and non-synchronized traces through the network in a per-hop view; GCL always opens the gate for 30 μs after the node in front of it; measurement duration: 300 minutes; 20 images per second; 512 bytes per frame
(a) synchronized trace
b) non-synchronized trace
(c) summarized synchronized trace based on the network location
(c) summarized non-synchronized trace based on the network location

FIG. 13: Synchronized traces through the network with cross traffic based on IMIX; measurement duration: 30 minutes; 20 images per second; 512 bytes per frame
(a) single image view with cross data traffic of the same and higher priority
(b) per-hop view with cross traffic of the same and higher priority
(c) single image view with cross traffic with lower priority and strict priority
(d) per-hop view with cross traffic of lower priority and strict priority
(e) single image view with cross traffic with lower priority and frame preemption
(f) per-hop view with cross traffic of lower priority and frame preemption

FIG. 14: Change of the TAS cycle time from 1 ms on “node 0” and “node 1” to 5 ms on “node 2” and “node 3” in synchronized topology; measurement duration: 60 minutes; 20 images per second; −512 bytes per frame

Table 2: Stream configuration for use case evaluation

FIG. 15: Synchronized trace through the network with cross traffic based on IMIX, resulting in congestion; duration of measurement: 30 minutes

1. A method of operating a network, wherein multiple network devices, each having their own configuration, are connected to one another for data exchange and exchange data via these connections, wherein dynamic delays (jitters) are taken into account in the determining of the time for the transmission of the data, wherein the network is a time-sensitive network, and wherein an actual time for the transmission of the data over the network devices from a starting network device to a target network device is determined while taking into account the dynamic delays, wherein time synchronization jitter and forwarding jitter are taken into account in the dynamic delays.

2. The method according to claim 1, wherein each network device inserts a timestamp in a data frame on its ingress port and on its egress port.

3. The method according to claim 1, wherein a theoretical time for the transmission of the data over the network device from the starting network device to the target network device is determined.

4. The method according to claim 3, wherein the actually determined time is compared with the theoretically determined time.

5. The method according to claim 4, wherein when the comparison exceeds a predeterminable threshold value, then the configuration of at least one network device is changed for debugging purposes between the starting network device and the target network device.

6. The method according to claim 5, wherein the configuration of the starting network device and/or the target network device is also changed.

7. The method according to claim 5, wherein the configuration of the at least one network device is changed until the comparison no longer exceeds the predeterminable threshold value.
